(19) United States
(12) Patent Application Publication
(10) Pub. No.: US 2020/0277445 A1
(43) Pub. Date: Sep. 3, 2020

(54) Polysiloxane Urethane Compounds and Optically Transparent Adhesive Compositions

(71) Applicants: Henkel IP & Holding GmbH, Duesseldorf (DE); Henkel AG & Co. KGaA, Duesseldorf (DE)

(72) Inventors: Shuhua Jin, Cheshire, CT (US); David P. Dworak, Middletown, CT (US); Qinyan Zhu, Cheshire, CT (US); Alfred A. DeCato, Highland, MI (US); Christina Despotopoulou, Minneapolis, MN (US)

(21) Appl. No.: 15/929,745

(22) Filed: May 20, 2020

Related U.S. Application Data
(63) Continuation of application No. PCT/US2018/062579, filed on Nov. 27, 2018.
(60) Provisional application No. 62/590,850, filed on Nov. 27, 2017.

(51) Int. Cl. C08G 77/38; C09J 183/04

(52) U.S. Cl. CPC C08G 77/38; C08G 2170/00; C09J 183/04

(57) ABSTRACT

Disclosed is a terminally functionalized polysiloxane urethane polymer comprising: polysiloxane segments comprising from 50 to 98% by weight based on the total polymer weight; urethane segments comprising from 2 to 50% by weight based on the total polymer weight; and terminal functional groups selected from (meth)acrylate functional groups, alkoxysilyl functional groups and mixtures thereof. The terminally functionalized polysiloxane urethane polymer finds use in liquid optically clear adhesive formulations wherein it can provide dual photo and moisture cure properties. In some embodiments cured reaction products of the liquid optically clear adhesive composition prepared with the terminally functionalized polysiloxane urethane polymer exhibit low haze of 2% or less and low yellowness b* values of 2 or less as prepared and after aging testing. In some embodiments cured reaction products of the liquid optically clear adhesive composition prepared with the terminally functionalized polysiloxane urethane polymer exhibit minimal shrinkage and a stable compression storage modulus from −40 to 100° C.

### TECHNICAL FIELD

This disclosure relates generally to liquid optically clear adhesives and more particularly to polysiloxane urethane compounds for use in liquid optically clear adhesives.

### BACKGROUND OF THE INVENTION

This section provides background information which is not necessarily prior art to the inventive concepts associated with the present disclosure.

Currently, in many electronic industry fields, such as the manufacture of LCD touch panels and display panels, adhesives are used to bond various substrates and assemblies together. Conventional adhesives used in such applications are cured by exposure to actinic radiation such as ultraviolet (UV) radiation or visible light. UV radiation is in the range of 100 to 400 nanometers (nm). Visible light is in the range of 400 to 780 nanometers (nm). However, complicated and special designs and opaque parts, such as those caused by ceramics and metals result in areas transparent to UV radiation and shadow areas that UV radiation and visible light cannot penetrate in display panels and touch panel devices. This is especially true for displays used in automotive display panels and other panels. These large shadow areas make it difficult to utilize adhesives that are cured by exposure to actinic radiation. These LOCA compositions are also used in other displays such as mobile phone screens, tablet screens and television screens and in formation of HHDD. Any adhesive utilized must also be as optically clear as possible, these adhesives are typically known as Liquid Optically Clear Adhesives (LOCA). Because of the difficulty in using a radiation only curable LOCA, in some cases manufacturing processes have moved to use of LOCA that are curable by exposure to both actinic radiation and thermal energy.

In addition to the radiation curable adhesives and thermally curable adhesives, conventional moisture curable LOCA adhesives can bond various kinds of substrates used in these systems. These LOCA compositions can be cured by exposure to moisture in the air or on the substrate to be bonded.

Silicone based actinic radiation and moisture curable LOCA compositions that are currently available tend to have very low modulus and low glass transition temperatures. While they have reasonable temperature range stability they have low compatibility with current visible light photoinitiators and moisture cure catalysts making it difficult to control adequate curing. These adhesives also tend to have high moisture permeability which results in development of excessive haze under high temperature and high humidity conditions. Organic acrylate based LOCA compositions have good compatibility with photoinitiators and can have low moisture permeability; however, they always exhibit high shrinkage and a wide range of glass transition temperatures which causes defects or delamination from plastic substrates during thermal cycling from −40° C. to 100° C. When one combines silicone based and organic acrylate based LOCAs together the resulting adhesive composition has an objectionably high level of haze because of incompatibility of the two polymers.

Any adhesive used to assemble these devices must meet several requirements including: an ability to cure in the large shadow areas where actinic radiation cannot penetrate; the ability to cure acceptably even when the actinic radiation is minimized by having to first pass through overlying plastic substrates; the ability to bond to a variety of materials including those formed from polymethylmethacrylate (PMMA), polycarbonate (PC) and/or polyethylene terephthalate (PET) a temperature ranges of from −40 to 100° C.; optical clarity in the cured state and very low hazing and yellowness values under conditions of high temperature, high humidity and strong UV radiation. There remains a need for a LOCA adhesive composition that can fulfill these criteria and that is curable by both exposure to actinic radiation and moisture.

### SUMMARY OF THE DISCLOSURE

This section provides a general summary of the disclosure and is not a comprehensive disclosure of its full scope or all features, aspects or objectives.

In an embodiment, the present disclosure provides a polysiloxane urethane polymer including: polysiloxane segments comprising from 50 to 98% by weight based on the total polymer weight; urethane segments comprising from 2 to 50% by weight based on the total polymer weight; and terminal functional groups selected from at least one of (meth)acrylate functional groups, alkoxysilyl functional groups, or mixtures thereof.

In an embodiment, the terminal functional groups comprise (meth)acrylate functional groups.

In an embodiment, the terminal functional groups comprise alkoxysilyl functional groups.

In an embodiment, the terminal functional groups comprise a mixture of (meth)acrylate functional groups and alkoxysilyl functional groups.

In an embodiment, the functionalized polymer has a number average molecular weight of from 1,000 to 100,000 and preferably from 3,000 to 40,000.

In an embodiment the disclosure provides a liquid optically clear adhesive composition comprising: a functionalized polysiloxane urethane polymer comprising polysiloxane segments comprising from 50 to 98% by weight based on the total polymer weight, urethane segments comprising from 2 to 50% by weight based on the total polymer weight and terminal functional groups comprising at least one of (meth)acrylate functional groups, alkoxysilyl functional groups, or mixtures thereof, the end-capped polysiloxane urethane polymer present in an amount of from 30 to 99.8% by weight based on the total composition weight; optionally, at least one (meth)acrylate monomer present in an amount of from 0 to 50% by weight based on the total composition weight; a photoinitiator present in an amount of from 0.01 to 3% by weight based on the total composition weight; optionally, a moisture curing catalyst present in an amount of from 0 to 1% by weight based on the total composition weight; and optionally one or more additives selected from the group consisting of photostabilizers, thermal stabilizers, leveling agents, thickeners and plasticizers, said additive present in an amount of from 0 to 5% by weight based on the total composition weight.

In an embodiment, the liquid optically clear adhesive composition comprises a functionalized polysiloxane urethane polymer having terminal (meth)acrylate functional groups.

In an embodiment, the liquid optically clear adhesive composition comprises a functionalized polysiloxane urethane polymer having terminal alkoxysilyl functional groups.

In an embodiment, the liquid optically clear adhesive composition comprises a functionalized polysiloxane urethane polymer having a mixture of terminal (meth)acrylate functional groups and terminal alkoxysilyl functional groups.

In an embodiment, the liquid optically clear adhesive composition comprises a functionalized polymer having a number average molecular weight of from 1,000 to 100,000 and preferably from 3,000 to 70,000.

In an embodiment, the liquid optically clear adhesive composition includes at least one of the (meth)acrylate monomers present in an amount of from 0 to 50% by weight, more preferably from 1 to 10% by weight based on the total composition weight.

In an embodiment, the liquid optically clear adhesive composition has a catalyst present in an amount of from 0.01 to 1% by weight based on the total weight of the composition.

In an embodiment, the liquid optically clear adhesive composition as prepared has a haze value of from 0 to 2%.

In an embodiment, the liquid optically clear adhesive composition has a haze value of from 0 to 2% after being stored for 500 hours at 85° C. and 85% relative humidity.

In an embodiment, the liquid optically clear adhesive composition as prepared has a yellowness b* value of from 0 to 2.

In an embodiment, the liquid optically clear adhesive has a yellowness b* value of from 0 to 2 after being stored for 500 hours at 85° C. and 85% relative humidity.

These and other features and advantages of this disclosure will become more apparent to those skilled in the art from the detailed description of a preferred embodiment.

### DETAILED DESCRIPTION OF A PREFERRED EMBODIMENT

The present disclosure is directed toward preparation of polysiloxane urethane polymers that comprise terminal functional groups selected from (meth)acrylates, alkoxysilyls, or mixtures thereof and use of these polymers in liquid optically clear adhesive (LOCA) compositions. The LOCA compositions preferably comprise: (A) the terminally functionalized polysiloxane urethane polymers according to the present disclosure; (B) optionally, (meth)acrylate monomers; (C) at least one of a photoinitiator or moisture cure catalyst; (D) optionally, the other of the photoinitiator or moisture cure catalyst; and (E) optionally additives. The LOCA compositions prepared according to the present disclosure are curable by exposure to at least one of and preferably by exposure to both ultraviolet (UV)/visible light and moisture.

The polysiloxane urethane polymers that are terminally functionalized with (meth)acrylates, alkoxysilyls, or mixtures thereof according to the present disclosure incorporate multiple organic segments and multiple silicone segments in the same polymer backbone. They are formed by reacting a hydroxyl terminated organopolysiloxane with an organic polyisocyanate or diisocyanate to form an organic-silicone block co-polymer that has a clear appearance.

The block organic-silicone co-polymers have terminating ends that comprise hydroxyl functional groups which can be further reacted to provide terminal (meth)acrylate and/or silyl trialkoxy functional groups. These terminal (meth)acrylate and/or silyl trialkoxy functional groups provide photocuring and moisture curing, respectively, to the polymers. The formed polysiloxane urethane polymers that are terminally functionalized with (meth)acrylates, alkoxysilyls, or mixtures thereof and LOCA compositions formed from them have surprisingly improved compatibility with photoinitiators and moisture cure catalysts compared to conventional LOCA adhesives. They also have lower moisture permeability than the silicone polymers and lower shrinkage compared to the organic acrylate polymers. These features make them ideal for many applications such as bonding of automotive displays and other structures, especially where both radiation curing and moisture curing are desirable.

### Component (A)

The compositions include the terminally functionalized polysiloxane urethane polymers. The terminally functionalized polysiloxane urethane polymers can be prepared by reacting a hydroxy terminated organopolysiloxanes and an organic isocyanate to form a polysiloxane urethane intermediate. The equivalents balance of OH to NCO moieties during the reaction should be chosen to provide the polysiloxane urethane intermediate with OH functionality. Preferably an excess of hydroxy functional moieties is used to ensure that the polysiloxane urethane intermediate has only terminal hydroxy groups.

Some useful hydroxyl terminated organopolysiloxanes have the following structure:

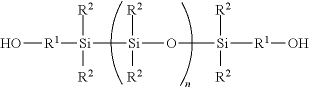

Each R¹ is independently chosen from C₁-C₁₂ alkyl, preferably C₁-C₆ alkyl, C₂-C₁₂ alkylether e.g. one or more O atoms between the C atoms, C₃-C₆ alicyclic and phenyl. Any R¹ can be independently substituted in any position by alkyl, alkoxy, halogen or epoxy moieties. Each R² is independently chosen from C₁-C₁₂ alkyl, preferably C₁-C₆ alkyl, C₃-C₆ alicyclic and phenyl. Any R² can be independently substituted in any position by alkyl, alkoxy, halogen or epoxy moieties. n can be an integer up to about 2,000, but n is more typically an integer from 1 to 200, preferably 5 to 200 and more preferably 10 to 150. Exemplary hydroxyl terminated organopolysiloxanes include the carbinol terminated polydimethylsiloxanes available from Gelest, Inc. and the linear polydimethylsiloxane propylhydroxy copolymers available from Siltech Corp and KF 6001, KF 6002 and KF 6003 available from Shin-Etsu Chemical. The Shin-Etsu Chemical materials are believed to have molecular weights from 1,000 to 10,000 and n values from 12 to 120.

The organic isocyanate is preferably an organic diisocyanate monomer. Some suitable organic diisocyanate monomers include aliphatic diisocyanates. Useful aliphatic diisocyanates include hexamethylene diisocyanate (HDI), methylene dicyclohexyl diisocyanate or hydrogenated MDI (HMDI) and isophorone diisocyanate (IPDI). Aromatic diisocyanates can develop haze and/or coloration and are not preferred for applications where optical clarity is desired.

The polysiloxane urethane intermediate is reacted with compounds containing (meth)acrylate groups and/or compounds containing alkoxysilyl groups to endcap some or all of the terminal OH moieties with (meth)acrylate groups and/or compounds containing alkoxysilyl groups. In some embodiments, less than 90%, for example 10% to 80%, or preferably 30% to 60% of the terminal OH moieties are endcapped with (meth)acrylate groups and/or alkoxysilyl groups. The terms group and moiety are used interchangeably herein. Preferably, the polysiloxane urethane intermediate comprising terminal OH moieties is reacted with isocyanatoalkyl (meth)acrylate compounds and/or isocyanatoalkyl alkoxysilyl compounds. In the present disclosure and claims the term (meth)acrylate is intended to mean, but is not limited to, corresponding derivatives of both acrylic acids and methacrylic acids. Some compounds containing (meth)acrylates useful to react with OH functional polysiloxane urethane polymers include, but are not limited to, isocyanato alkyl (meth)acrylates such as 2-isocyanatoethyl acrylate, 2-isocyanatoethyl methacrylate, 3-isocyanatopropyl (meth)acrylate, 2-isocyanatopropyl (meth)acrylate, 4-isocyanatobutyl (meth)acrylate, 3-isocyanatobutyl (meth)acrylate, and 2-isocyanatobutyl (meth)acrylate. Useful isocyanate containing alkoxy silanes to impart moisture curing include 3-isocyanato propyl trimethoxysilane, 3-isocyanato propyl triethoxysilane, and 3-isocyanato propyl methyl dimethoxysilane

The resulting polysiloxane urethane polymer comprises an organic-silicone block copolymer with multiple urethane blocks and multiple organosiloxane blocks in the backbone. Each end of the backbone will have a terminal position. Each terminal position can independently be a hydroxyl moiety, a (meth)acrylate moiety or an alkoxysilyl moiety.

In some embodiments, some or all of the remaining hydroxyl moieties can be further reacted to provide that terminal end with a desired moiety other than a (meth)acrylate moiety or an alkoxysilyl moiety. For example, some or all of the remaining terminal hydroxyl moieties can be reacted with an alkyl isocyanate such as methyl isocyanate, ethyl isocyanate, octyl isocyanate; or acetyl chloride.

Preferably the multiple silicone segments of the terminally functionalized polysiloxane urethane polymers prepared according to the present disclosure comprise from 50 to 98% by weight of the polymer, more preferably from 80 to 98% by weight based on the total polymer weight. Preferably the multiple organic urethane segments, comprise from 2 to 50% by weight of the polymer, and more preferably from 2 to 20% by weight based on the total polymer weight. Preferably the terminally functionalized polysiloxane urethane polymers designed according to the present disclosure have a number average molecular weight of from 1,000 to 100,000, more preferably from 3,000 to 70,000. Preferably the terminally functionalized polysiloxane urethane polymers according to the present disclosure are used in the LOCA composition in an amount of from 30 to 99.8% by weight, more preferably from 50 to 95% by weight based on the total weight of the LOCA composition.

Preferred terminal alkoxysilyl groups or moieties have the following formula I:

—Si(OR¹)ₐR²₃₋ₐ Formula I
wherein “a” is an integer from 1 to 3, preferably from 2 to 3, particularly preferred 2; each R¹ is independently selected from a C₁-C₁₀ alkyl, preferably methyl, ethyl, n-propyl, iso-propyl, and n-butyl, particularly preferred from methyl, and ethyl, and more particularly preferred each R¹ is methyl; and each R² is independently selected from C₁-C₁₀ alkyl, preferably methyl, ethyl, n-propyl, iso-propyl, and n-butyl, particularly preferred from methyl, and ethyl, and more particularly preferred each R² is methyl.

### Component (B)

The compositions optionally include one or more (meth)acrylate monomers. The optional (meth)acrylate monomers used in the present disclosure are not especially limited and can comprise one or more derivatives of acrylic acids and (meth)acrylic acids. The (meth)acrylate monomer may be a monofunctional (meth)acrylate monomer, i.e., one (meth)acrylate group is contained in the molecule, or it can be a multifunctional (meth)acrylate monomer, i.e., two or more (meth)acrylate groups are contained in the molecule. The suitable monofunctional (meth)acrylate monomers include, by way of example only and not limitation: butylene glycol mono(meth)acrylate; hydroxyethyl (meth)acrylate; hydroxylpropyl (meth)acrylate; hydroxybutyl(meth)acrylate; isooctyl (meth)acrylate; tetrahydrofuranyl (meth)acrylate; cyclohexyl (meth)acrylate; dicyclopentanyl (meth)acrylate; dicyclopentanyloxy ethyl (meth)acrylate; N,N-diethylaminoethyl (meth)acrylate; 2-ethoxyethyl (meth)acrylate; 2-hydroxyethyl (meth)acrylate; 2-hydroxypropyl (meth)acrylate; caprolactone modified (meth)acrylate; isobornyl (meth)acrylate; lauryl (meth)acrylate; acryloylmorpholine; N-vinylcaprolactam; nonylphenoxypolyethylene glycol (meth)acrylate; nonylphenoxypolypropylene glycol (meth)acrylate; phenoxy ethyl (meth)acrylate; phenoxy hydropropyl (meth)acrylate; phenoxy di(ethylene glycol) (meth)acrylate; polyethylene glycol (meth)acrylate and tetrahydrofuranyl (meth)acrylate. The suitable multifunctional (meth)acrylate monomer can include, by way of example and not limitation: 1,4-butylene glycol di(meth)acrylate; dicyclopentanyl di(meth)acrylate; ethylene glycol di(meth)acrylate; dipentaerythritol hexa(meth)acrylate; caprolactone modified dipentaerythritol hexa(meth)acrylate; 1,6-hexanediol di(meth)acrylate; neopentyl glycol di(meth)acrylate; pentaerythritol tri(meth)acrylate; polyethylene glycol di(meth)acrylate; tetraethylene glycol di(meth)acrylate; trimethylolpropane tri(meth)acrylate; tris(acryloyloxyethyl) isocyanurate; caprolactone modified tris(acryloyloxyethyl) isocyanurate; tris(methylacryloyloxyethyl) isocyanurate and tricyclodecane dimethanol di(meth)acrylate. The monofunctional (meth)acrylate monomers and multifunctional (meth)acrylate monomers may be used individually or in a combination of two or more monomers, respectively, or the monofunctional (meth)acrylate monomer and multifunctional (meth)acrylate monomer can be combined together. Preferably, when present, the (meth)acrylate monomer is present in the LOCA composition in an amount of from 0 to 50% by weight, more preferably from 1 to 10% by weight based on the total weight of the LOCA composition.

### Component (C)

The compositions include one or more photoinitiators. The photoinitiator is used to initiate the radiation cure crosslinking of the terminal (meth)acrylate groups and (meth)acrylate monomer, if present. The suitable photoinitiators are any free radical initiator known in the art, and preferably is one or more selected from, for example: benzil ketals; hydroxyl ketones; amine ketones and acylphosphine oxides, such as 2-hydroxy-2-methyl-1-phenyl-1-acetone; diphenyl (2,4,6-triphenylbenzoyl)-phosphine oxide; 2-benzyl-dimethylamino-1-(4-morpholinophenyl)-butan-1-one; benzoin dimethyl ketal dimethoxy acetophenone; a-hydroxy benzyl phenyl ketone; 1-hydroxy-1-methyl ethyl phenyl ketone; oligo-2-hydoxy-2-methyl-1-(4-(1-methyvinyl)phenyl)acetone; benzophenone; methyl o-benzyl benzoate; methyl benzoylformate; 2-diethoxy acetophenone; 2,2-disec-butoxyacetophenone; p-phenyl benzophenone; 2-isopropyl thioxanthenone; 2-methylanthrone; 2-ethylanthrone, 2-chloroanthrone; 1,2-benzanthrone; benzoyl ether; benzoin ether; benzoin methyl ether; benzoin isopropyl ether; α-phenyl benzoin; thioxanthenone; diethyl thioxanthenone; 1,5-acetonaphthone; 1-hydroxycyclohexylphenyl ketone; ethyl p-dimethylaminobenzoate; Michler's ketone; dialkoxyacetophenones such as diethoxyacetophenone (DEAP). These photoinitiators may be used individually or in combination. In the LOCA compositions of the present invention, based on the total weight of the LOCA composition, the amount of the photoinitiator is preferably from about 0.02 to 3% by weight, more preferably from 0.3 to 1% by weight. The photoinitiator used in the present disclosure may be a commercially available one, including, for example, Irgacure 184 and Irgacure TPO-L from BASF Corporation.

### Component (D)

The compositions optionally include one or more moisture cure catalysts, preferably organometallic catalysts. The optionally included organometallic catalysts suitable for use according to the present disclosure are not particularly limited, and can comprise stannous octanoate, dibutyltin dilaurate, dibutyltin diacetate, bismuth based catalysts such as bismuth carboxylate and other known organometallic catalysts. These organometallic catalysts are clear to pale yellow liquids, and can be used to accelerate the moisture curing reaction. In the LOCA compositions of the present disclosure, based on the total weight of the composition, the amount of the organometallic catalyst present when in the formulation is preferably from 0.005 to 1% by weight, more preferably from 0.05 to 0.2% by weight.

### Component (E)

The compositions can optionally further comprise one or more additives selected from photostabilizers, fillers, thermal stabilizers, leveling agents, thickeners and plasticizers. A person skilled in the art would realize the detailed examples of each of these types of the additives and how to combine them to achieve desired properties in the composition. Preferably, the total amount of additives, based on the total weight of the LOCA composition, is from 0 to 5% by weight, more preferably 0 to 2% by weight, particularly preferred 0 to 1% by weight based on the total weight of the LOCA composition.

The LOCA compositions according to the present disclosure preferably have a haze value of from 0 to 2, more preferably from 0 to 1. The LOCA compositions according to the present disclosure preferably have a yellowness (b*) value of from 0 to 2, more preferably from 0 to 1.

### EXAMPLES

### Test Methods

The viscosity of each polymer was measured at 25° C. at 12 reciprocal seconds using a cone and plate rheometer. The results are reported in units of millipascal seconds (mPa·s).

The ultraviolet (UV) curing was conducted using a mercury arc lamp with UV irradiation energy of about 3000 mJ/cm² or more. Moisture curing was conducted in a humidity chamber at 23±2° C., 50±10% relative humidity (RH). UV and moisture dual curing was performed by first curing the compositions with the mercury arc light and then the adhesives were placed in a humidity chamber and moisture cured for the indicated period of time. Shore 00 hardness was measured according to ASTM D2240.

Laminated samples were prepared by placing a layer of adhesive between two glass slides, the layer having a coating thickness of 12.5 mil which is about 318 microns (μ), and then curing the adhesive by UV light as described previously. After the samples were cured they w tested for transmittance, haze and the yellowness b* value using a Datacolor 650 apparatus available from Datacolor Corporation, in compliance with ASTM D1003. Thereafter the samples were subjected to reliability testing conditions and the measurements were repeated. The laminated samples were then placed at high humidity, high temperature, 85° C./85% RH, for 500 hours to observe if any defects developed after aging.

The photo rheometer measurements were performed at 25° C. using an Anton Paar rheometer MCR302 using Light guide Omnicure 2000 with an intensity of 100 mw/cm².

Dynamic Mechanical Analysis (DMA) Temperature Ramp Test, Compression mode, was tested using a RSA III Instrument: RSA by cylindrical compression tool. The sample was a disk with a diameter of 7.0 mm and a thickness of about 3 mm at a temperature range of −50 to 100° C. with a temperature ramp rate of 5° C./minute.

Unless otherwise specified molecular weight is weight average molecular weight Mw. The weight average molecular weight M_{w}, is generally determined by gel permeation chromatography (GPC, also known as SEC) at 23° C. using a styrene standard. This method is known to one skilled in the art.

### Example 1

### Preparation of 50% Acrylated Organo-Silicone Polyurethane (1.4:1 OH:NCO)

To a jacketed reaction vessel equipped with an overhead stirrer, thermocouple, and a nitrogen inlet/outlet was added a linear di-functional hydroxyl-terminated silicone pre-polymer Silmer OH D-50 from Siltech Corporation (110.92 g, 0.055 moles), dibutyltin dilaurate (0.36 millimoles (mmol)), and this mixture was heated to 60° C. under nitrogen. The Silmer OH D-50 has a molecular weight of 4,000 and a hydroxyl value of 28. Once at temperature 1,6-hexane diisocyanate (3.39 g, 0.020 moles) was added and allowed to mix for 3 hours under nitrogen. Fourier transform infrared spectroscopy (FT-IR) was used to monitor the reaction progress and the disappearance of the NCO band at 2200 cm⁻¹ was evidence that the A-stage reaction was complete. Next, 2-isocyanatoethyl acrylate (1.14 g, 0.008 moles) was added and allowed to react for 3 hours at 60° C. under nitrogen. Again FT-IR was used to monitor the reaction progress and the disappearance of the NCO band at 2200 cm⁻¹ was evidence that the B-stage reaction was complete to yield a liquid, clear and colorless functionalized organo-silicone polyurethane wherein about 50% of the terminal groups are acrylate moieties and about 50% of the terminal groups are unreacted OH moieties.

### Example 2

### Preparation of 40% Acrylated/60% Trimethoxy Silane Functionalized Organo-Silicone Polyurethane (1.4:1 OH:NCO)

To a jacketed reaction vessel equipped with an overhead stirrer, thermocouple, and a nitrogen inlet/outlet was added Silmer OH D-50 (54.41 g, 0.027 moles), dibutyltin dilaurate (0.03 mmol), and this mixture was heated to 60° C. under nitrogen. Once at temperature 1,6-hexane diisocyanate (1.66 g, 0.010 moles) was added and allowed to mix for 3 hours under nitrogen. FT-IR was used to monitor the reaction progress and the disappearance of the NCO band at 2200 cm⁻¹ was evidence that the A-stage reaction was complete. Next, 2-isocyanatoethyl acrylate (0.45 g, 3.2 mmol) and 3-isocyanatopropyltrimethoxysilane (0.97 g, 4.7 mmol) were added and allowed to react for 3 hours at 60° C. under nitrogen. Again FT-IR was used to monitor the reaction progress and the disappearance of the NCO band at 2200 cm⁻¹ was evidence that the B-stage reaction was complete to yield a liquid, clear and colorless functionalized organo-silicone polyurethane wherein about 40% of the terminal groups are acrylate moieties and about 60% of the terminal groups are trimethoxysilane moieties.

### Example 3

### Preparation of 100% Acrylated Organo-Silicone Polyurethane (1.4:1 OH:NCO)

To a jacketed reaction vessel equipped with an overhead stirrer, thermocouple, and a nitrogen inlet/outlet was added Silmer OH D-50 (74.59 g, 0.037 moles), dibutyltin dilaurate (0.04 mmol), and this mixture was heated to 60° C. under nitrogen. Once at temperature 1,6-hexane diisocyanate (2.28 g, 0.013 moles) was added and allowed to mix for 3 hours under nitrogen. FT-IR was used to monitor the reaction progress and the disappearance of the NCO band at 2200 cm⁻¹ was evidence that the A-stage reaction was complete. Next, 2-isocyanatoethyl acrylate (1.53 g, 0.010 moles) was added and allowed to react for 3 hours at 60° C. under nitrogen. Again FT-IR was used to monitor the reaction progress and the disappearance of the NCO band at 2200 cm⁻¹ was evidence that the B-stage reaction was complete to yield a liquid, clear and colorless functionalized organo-silicone polyurethane wherein 100% of the terminal groups are acrylate moieties.

### Example 4

### Preparation of 50% Acrylated Organo-Silicone Polyurethane (1.3:1 OH:NCO)

To a jacketed reaction vessel equipped with an overhead stirrer, thermocouple, and a nitrogen inlet/outlet was added a difunctional α-hydroxyl ether terminated polydimethylsiloxane (PMDS) from NuSil Technologies, (51.23 g, 0.061 moles), dibutyltin dilaurate (0.02 mmol), and this mixture was heated to 60° C. under nitrogen. Once at temperature 1,6-hexane diisocyanate (4.03 g, 0.024 moles) was added and allowed to mix for 3 hours under nitrogen. FT-IR was used to monitor the reaction progress and the disappearance of the NCO band at 2200 cm⁻¹ was evidence that the A-stage reaction was complete. Next, 2-isocyanatoethyl acrylate (1.01 g, 0.007 moles) was added and allowed to react for 3 hours at 60° C. under nitrogen. Again FT-IR was used to monitor the reaction progress and the disappearance of the NCO band at 2200 cm⁻¹ was evidence that the B-stage reaction was complete to yield a liquid, clear and colorless functionalized organo-silicone polyurethane wherein about 50% of the terminal groups are acrylate moieties and about 50% of the terminal groups are unreacted OH moieties. Weight average molecular weight is 23,000.

### Example 5

### Preparation of 40% Acrylated/40% Trimethoxy Silane Functionalized Organo-Silicone Polyurethane (1.3:1 OH:NCO)

To a jacketed reaction vessel equipped with an overhead stirrer, thermocouple, and a nitrogen inlet/outlet was added a difunctional α-hydroxyl ether terminated PMDS from NuSil Technologies, (1,125.9 g, 1.413 moles), dibutyltin dilaurate (0.4 mmol), and this mixture was heated to 60° C. under nitrogen. Once at temperature 1,6-hexane diisocyanate (92.0 g, 0.547 moles) was added and allowed to mix for 3 hours under nitrogen. FT-IR was used to monitor the reaction progress and the disappearance of the NCO band at 2200 cm⁻¹ was evidence that the A-stage reaction was complete. Next, 2-isocyanatoethyl acrylate (18.53 g, 0.131 moles) and 3-isocyanatopropyltrimethoxysilane (26.95 g, 0.131 moles) were added and allowed to react for 3 hours at 60° C. under nitrogen. Again FT-IR was used to monitor the reaction progress and the disappearance of the NCO band at 2200 cm⁻¹ was evidence that the B-stage reaction was complete to yield a liquid, clear and colorless functionalized organo-silicone polyurethane wherein about 40% of the terminal groups are acrylate moieties, about 40% of the terminal groups are trimethoxysilane moieties and the remaining 20% of the terminal groups are unreacted OH moieties. Weight average molecular weight is 20,500.

### Example 6

### Organo-Silicone Polyurethane Property Evaluation

The compatibility of visible photoinitiator Irgacure TPO-L, a 2,4,6-trimethylbenzoylphenyl phosphinate available from BASF, and a hydrophilic acrylate monomer hydroxylpropylacrylate (I-IPA) with all five of the organo-silicone polyurethanes prepared according to the present disclosure, examples 1-5 from above, was tested. Two UV curable silicone polymers with comparable viscosities were used as comparative examples. The two comparative silicone polymers, silicone polymers A and B, were acrylate terminated polydimethylsiloxane prepared as described in Example 3 of U.S. Pat. No. 5,663,269. Briefly, 500 g of a silanol terminated polydimethylsiloxane (PDMS) fluid (Mw 28,000 for silicone polymer A and Mw 12,000 for silicone polymer B) is placed in a 1000 ml three neck round bottom flask. Then 14 g of methacryloxypropyltimethoxysilane was added. To the stirred mixture was further added 0.65 g of lithium n-butyldimethylsilanolate solution previously prepared (i.e., 15 ppm Li). The mixture was stirred at room temperature under nitrogen for 3 hours. The temperature of the mixture rose to 50° C. due to shearing. A gentle stream of carbon dioxide was babbled into the system for 10 minutes for catalyst quenching. The mixture was then heated to 110″ C. under nitrogen sparge for 30 minutes to remove volatile materials. The mixture was then allowed to cool down to room temperature.

To test compatibility, 0.3% of the photoinitiator Irgacure TPO-L or 1% of hydroxylpropylacrylate (HPA) monomer was added into the polymer and mixed, the percentages being percent by weight based on the total weight of the composition. The mixture was placed in a clear glass vial to visually check its clarity. It was marked as clear if it showed similar clarity as the original polymer, and marked as hazy if cloudiness was observed in the mixture. Testing results are shown in Table 1 below.

TABLE 1

| | Viscosity | Compatibility test | Compatibility test |
|---|---|---|---|
| Example | (mPa · s) | with Irgacure TPO-L | with (HPA) |
| Example 1 | 5,176 | Clear | Clear |
| Example 2 | 5,189 | Clear | Clear |
| Example 3 | 1,990 | Clear | Clear |
| Example 4 | 4,870 | Clear | Clear |
| Example 5 | 4,723 | Clear | Clear |
| Comparative | 6,500 | Hazy | Hazy |
| silicone | | | |
| polymer A | | | |
| Comparative | 2,300 | Hazy | Hazy |
| silicone | | | |
| polymer B | | | |

The polysiloxane urethanes of Examples 1-5 showed good compatibility with both 0.3% of the visible photoinitiator 2,4,6-trimethylbenzoylphenyl phosphinate and the 1% HPA while comparative silicone polymers A and B, which have a similar viscosity but do not have multiple organic urethane segments in the backbone, have low compatibility with these two components.

### Example 7

### Light Curable Optical Clear Adhesive Formulation and Properties

Formulations 6 and 7 were prepared using UV curable polysiloxane urethane Examples 1 and 4. Comparative formulations E and F were prepared using commercially available polydimethylsilicone acrylate polymers (Silmer ACR Di 10 and Silmer Di-50, both are from Siltech Corp, respectively). The two comparative polymers have a lower molecular weight (molecular weight 1,000 for Silmer ACR Di 10 and 4,000 for Silmer Di-50) and were chosen because of their good compatibility with Irgacure TPO and HPA. The light curable formulations were tested for their Shore 00 hardness and a variety of optical properties as cured before and after aging for 500 hours at 85° C. and 85% RH. The light curable formulations and test results are summarized in Table 2 and Table 3 below, respectively.

TABLE 2

| Example | 6 | 7 | E | F |
|---|---|---|---|---|
| Component | Wt. % | Wt. % | Wt. % | Wt. % |
| Example 1 | 98.7 | | | |
| Example 4 | | 93.7 | | |
| Silmer ACR Di 10 | | | 98.7 | |
| Silmer ACR Di 50 | | | | 98.7 |
| Hydroxylpropyl acrylate | 1 | 6 | 1 | 1 |
| Irgacure TPO | 0.3 | 0.3 | 0.3 | 0.3 |
| Total | 100 | 100 | 100 | 100 |

TABLE 3

| Example | 6 | 7 | E | F |
|---|---|---|---|---|
| Shore 00 hardness | 28 | 32 | 82 | 70 |
| Optical properties (initial) | | | | |
| Haze (%) | 0.1 | 0 | 0.1 | 0.2 |
| Yellowness b* | 0.10 | 0.09 | 0.55 | 0.40 |
| Optical properties (after 500 | | | | |
| hr at 85° C./85% RH) | | | | |
| Haze (%) | 0.7 | 0 | 3.2 | 1.8 |
| Yellowness b* | 0.19 | 0.22 | 0.61 | 0.6 |

Formulations 6 and 7 prepared with the UV curable polysiloxane urethanes of examples 1 and 4 had Shore 00 hardness values suitable for LOCA applications. Formulations E and F prepared from comparative silicone acrylate polymers had much higher and less desirable Shore 00 hardness values. The optical properties as initially prepared and after 500 hours of aging reliability testing under 85° C./85% RH of formulations 6 and 7 based on inventive UV curable organo-silicone polyurethanes 1 and 4 were very good. Formulations E and F containing comparative commercial silicone acrylate polymers showed much higher yellowness and haze values both initially and after aging which are less desirable in a LOCA application.

### Example 8

### Light and Moisture Dual Curable Optical Clear Adhesive Formulations and Properties

UV and moisture curable formulations 8 and 9 were prepared using UV and moisture curable polysiloxane urethane of Examples 2 and 5. UV and moisture curable formulations G and H were prepared using comparative silicone polymers A and B. The formulations and test results are summarized in Table 4 and Table 5 below.

TABLE 4

| Example | 8 | 9 | G | H |
|---|---|---|---|---|
| Component | Wt. % | Wt. % | Wt. % | Wt. % |
| Example 2 | 98.75 | | | |
| Example 5 | | 93.75 | | |
| Comparative silicone acrylate | | | 98.75 | |
| polymer A | | | | |
| Comparative silicone acrylate | | | | 98.75 |
| polymer B | | | | |
| Hydroxyethyl acrylate | 1 | | | |
| Hydroxypropyl acrylate | | 6 | | |
| Vinyl trimethoxysilanel | | | 1 | 1 |
| Irgacure TPO | 0.2 | 0.2 | 0.2 | 0.2 |
| Tin catalyst | 0.05 | 0.05 | 0.05 | 0.05 |
| Total | 100 | 100 | 100 | 100 |

1 (Dynasylan ® VTMO from Evonik Industries)

TABLE 5

| Example | 8 | 9 | G | H |
|---|---|---|---|---|
| Shore 00 hardness | | | | |
| UV cure | 15 | 30 | 20 | 45 |
| Moisture cure | 12 | 15 | 55 | 65 |
| Optical properties (initial) | | | | |
| Haze (%) | 0.2 | 0.1 | 0 | 0.2 |
| Yellowness b* | 0.20 | 0.18 | 0.08 | 0.11 |
| Optical properties (after aging | | | | |
| for 500 hr at 85° C./85% RH) | | | | |
| Haze (%) | 0.2 | 0 | 9.9 | 1.2 |
| Yellowness b* | 0.27 | 0.25 | −0.32 | 0.43 |

Formulations 8 and 9 comprising inventive UV and moisture curable polysiloxane urethanes 2 and 5 can be cured by UV/Visible light and moisture. Under all curing conditions, the cured products of formulations 8 and 9 had a Shore 00 hardness that is suitable for LOCA applications. Both formulations 8 and 9 have low haze and yellowness b* values after UV and moisture curing. After 500 hours under 85° C./85% RH for age testing, both haze and yellowness b* values are still low in the examples according to the present disclosure. By way of contrast formulations G and H based on comparative UV and moisture curable silicone acrylate polymers A and B have very good initial optical properties; however after 500 hours of aging at 85° C./85% RH RA both haze values undesirably increased significantly and the yellowness b* values were also significantly altered. Yellowness b* values are measured using a standard as the blank sample. A negative yellowness b* value indicates a value that is lower than the value of the standard blank sample. In Example 12 the negative yellowness b* value is believed due to suppression caused by the high haze value.

### Example 8

### Comparative Properties of an Argano-Silicone Polyurethane Containing Formulation with Silicone LOCA and Acrylate LOCA by Photo Rheometer Study

TABLE 6

| | Maximum | time to reach | |
|---|---|---|---|
| | Storage | 90% of Maximum | linear |
| | modulus | Storage modulus | shrinkage |
| Material | (KPa) | (seconds) | (%) |
| Comparative commercial | 21 | 55 | 1 |
| organic acrylate LOCA¹ | | | |
| formulation H | 28 | 172 | 0 |
| formulation 8 | 26 | 37 | 0.13 |

¹LOCTITE 3199 available from Henkel Corp.

Inventive polysiloxane urethane formulation 8 has a much faster light curing speed than the comparative silicone acrylate formulation H and has a comparative light curing speed to the commercially available acrylate LOCA. Inventive formulation 8 has a much lower shrinkage than the commercially available acrylate LOCA.

### Example 9

### Comparative Properties of Polysiloxane Urethane Polymer Containing LOCA Formulation with Comparative Silicone LOCA and Comparative Acrylate LOCA by Compression Modulus/Temperature DMA Tests.

Compression mode DMA tests were performed on three LOCA formulations. Table 7 lists the compression storage modulus at several selected temperatures from −40 to 90° C.

TABLE 7

| | Compression storage modulus (KPa) | | | | |
|---|---|---|---|---|---|
| | at different temperatures (° C.) | | | | |
| Material | −40° C. | 0° C. | 25° C. | 50° C. | 90° C. |
| Comparative commercial | 150,000 | 104 | 88 | 90 | 100 |
| organic acrylate LOCA¹ | | | | | |
| formulation H | 12 | 12 | 12 | 12 | 14 |
| formulation 8 | 188 | 80 | 74 | 76 | 86 |

¹LOCTITE 3199 available from Henkel Corp.

For the commercial organic acrylate adhesive the compression storage modulus at low temperature (−40° C.). was undesirably more than 1,000 times higher than that at temperatures above 0° C. For formulation H, a silicone acrylate with PDMS as the backbone, the compression storage modulus did not change over the temperature range of −40 to 90° C. However as shown in the earlier testing formulation H has undesirable changes in yellowness b* and haze values over time. Formulation 8 had a modulus at temperatures above 0° C. that is only about twice the value at −40° C., which is a significant improvement over the results obtained from the commercial organic acrylate adhesive. The inventive formulations have low haze and yellowness b* values both initially and after aging testing. In addition, they have quite stable compression modulus values over a temperature range of from −40 to 100° C. They provide a rapid cure rate and very low shrinkage values. In addition, the inventive formulations have Shore 00 values that are beneficially low. These results demonstrate the usefulness of the inventive polysiloxane urethane polymers end-capped with (meth)acrylates, alkoxysilyls, or mixtures thereof. The disclosed polysiloxane urethane polymers when used in LOCA formulations offer distinct advantages over presently available LOCA formulations. The disclosed polysiloxane urethane polymers and formulations solve the need for a dual curing LOCA composition.

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an amount, concentration, or other value or parameter is given as either a range, a preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

We claim:

1. A terminally functionalized polysiloxane urethane polymer, the polymer having a backbone comprising:
multiple organopolysiloxane segments, the organopolysiloxane segments comprising from 50 to 98% by weight based on the total polymer weight;
multiple urethane segments, the urethane segments comprising from 2 to 50% by weight based on the total polymer weight; and
a group that is terminally positioned on the backbone and selected from a (meth)acrylate moiety and an alkoxysilyl moiety.

2. A functionalized polysiloxane urethane polymer as recited in claim 1, comprising 80 to 98% by weight based on the total polymer weight of organopolysiloxane segments; and 2 to 20% by weight based on the total polymer weight of urethane segments.

3. A functionalized polysiloxane urethane polymer as recited in claim 1, comprising the group terminally positioned on the backbone and selected from a (meth)acrylate moiety and an alkoxysilyl moiety and a second hydroxyl moiety terminally positioned on the backbone.

4. A plurality of the terminally functionalized polysiloxane urethane polymers as recited in claim 1, wherein 30 to 60% of the terminal functional groups in the plurality are (meth)acrylate functional groups.

5. A terminally functionalized polysiloxane urethane polymer as recited in claim 1, comprising a terminally positioned (meth)acrylate moiety.

6. A terminally functionalized polysiloxane urethane polymer as recited in claim 1, comprising a terminally positioned alkoxysilyl moiety.

7. A terminally functionalized polysiloxane urethane polymer as recited in claim 1, comprising a terminally positioned (meth)acrylate moiety and a terminally positioned alkoxysilyl moiety.

8. A functionalized polysiloxane urethane polymer as recited in claim 1, comprising the group terminally positioned on the backbone and selected from a (meth)acrylate moiety and an alkoxysilyl moiety and a second moiety terminally positioned on the backbone that is not a (meth)acrylate moiety or an alkoxysilyl moiety.

9. A terminally functionalized polysiloxane urethane polymer as recited in claim 1, wherein said polymer has a number average molecular weight of from 3,000 to 70,000.

10. A liquid optically clear adhesive composition comprising:
30 to 99.8% by weight based on the total composition weight of the terminally functionalized polysiloxane urethane polymer of claims 1;
0 to 50% by weight based on the total composition weight of at least one (meth)acrylate monomer;
at least one of a photoinitiator or a moisture curing catalyst;
optionally the other of a photoinitiator or a moisture curing catalyst; and
0 to 5% by weight based on the total composition weight of one or more additives selected from photostabilizer, filler, thermal stabilizer, leveling agent, thickener and plasticizer.

11. A liquid optically clear adhesive composition as recited in claim 10, wherein said terminally functionalized polysiloxane urethane polymer comprises both terminal (meth)acrylate functional groups and terminal alkoxysilyl functional groups.

12. A liquid optically clear adhesive composition as recited in claim 10, being UV curable and moisture curable.

13. A liquid optically clear adhesive composition as recited in claim 10, comprising 1 to 10% by weight based on the total composition weight of the at least one (meth)acrylate monomers.

14. A liquid optically clear adhesive composition as recited in claim 10, comprising 0.005 to 1% by weight based on the total weight of the composition of the catalyst, wherein the catalyst is a moisture curing catalyst.

15. Cured reaction products of the liquid optically clear adhesive composition as recited in claim 10, having a haze value of from 0 to 2%.

16. Cured reaction products of the liquid optically clear adhesive composition as recited in claim 10, having a haze value of from 0 to 2% after being stored for 500 hours at 85° C. and 85% relative humidity.

17. Cured reaction products of the liquid optically clear adhesive composition as recited in claim 10, having a yellowness b* value of from 0 to 2.

18. Cured reaction products of the liquid optically clear adhesive composition as recited in claim 10, having a yellowness b* value of from 0 to 2 after being stored for 500 hours at 85° C. and 85% relative humidity.

19. A method of making a curable polysiloxane urethane polymer comprising:
providing a hydroxy terminated organopolysiloxane;
providing an aliphatic diisocyanate;
reacting an excess of equivalents of the hydroxy terminated organopolysiloxane with the aliphatic diisocyanate to form a hydroxy functional polysiloxane urethane intermediate; and
reacting the hydroxy functional polysiloxane urethane intermediate with an isocyanate functional compound containing (meth)acrylate groups and/or an isocyanate functional compound containing compound containing alkoxysilyl groups to provide the curable polysiloxane urethane polymer.
